(19) United States
(12) Patent Application Publication
(10) Pub. No.: US 2014/0365393 A1
(43) Pub. Date: Dec. 11, 2014

(54) TRANSPORTATION CAPACITY AUGMENTATION PROGRAM METHODS, APPARATUSES AND MEDIA

(71) Applicant: DoDat Process Technology, LLC, Jacksonville, FL (US)

(72) Inventor: Timothy G. Taylor, Naples, FL (US)

(21) Appl. No.: 13/912,786

(22) Filed: Jun. 7, 2013

(51) Int. Cl. G06Q 10/08

(52) U.S. Cl. CPC G06Q 10/08345
USPC 705/335

(57) ABSTRACT

A request to determine carriers for freight may be received. Additional capacity desired to facilitate shipping of the freight may be determined. A quote for shipping at least a portion of the freight may be obtained from a non-core carrier and the non-core carrier may be chosen to provide at least a portion of the desired additional capacity based on the obtained quote. Shipping of at least a portion of the remaining freight may be assigned to a core carrier.

This disclosure describes TRANSPORTATION CAPACITY AUGMENTATION PROGRAM METHODS, APPARATUSES AND MEDIA (hereinafter “TCAP™”). A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

### FIELD

The present disclosure is directed generally to optimization platforms.

### BACKGROUND

Shippers, such as clothing manufacturers, ship freight to a variety of destinations. For example, clothing manufacturers may ship clothing to distributers or retailers. Some shippers utilize contract carriers to ship their freight. Some shippers utilize open market carriers to ship their freight. Carriers may ship freight using equipment such as trucks, boats, trains, airplanes, and/or the like.

### BRIEF DESCRIPTION OF THE FIGURES

The accompanying figures and/or appendices illustrate various exemplary embodiments in accordance with the present disclosure.

FIG. 1 shows an exemplary usage scenario in one embodiment of the TCAP™ platform.

FIG. 2 shows a logic flow diagram illustrating a freight distribution determining (FDD) component in one embodiment of the TCAP™ platform.

FIG. 3 shows a data flow diagram in one embodiment of the TCAP™ platform.

FIG. 4 shows a logic flow diagram illustrating a non-core carrier determining (NCD) component in one embodiment of the TCAP™ platform.

FIG. 5 shows a block diagram illustrating an exemplary TCAP™ coordinator in one embodiment of the TCAP™ platform.

### DETAILED DESCRIPTION

### Introduction

The TCAP™ platform introduces an optimization platform that may facilitate effective shipping of freight. If a user wishes to ship more freight than the available capacity of the user's core carriers allows, the user may utilize the TCAP™ platform to offer any of the available freight loads on the open market to non-core carriers. The TCAP™ platform may facilitate assigning freight loads in excess of the available capacity of the user's core carriers to interested non-core carriers in such a way as to minimize the cost to the user of delivering the freight, and facilitate assigning the remaining freight loads to core carriers.

### DETAILED DESCRIPTION OF THE TCAP™ PLATFORM

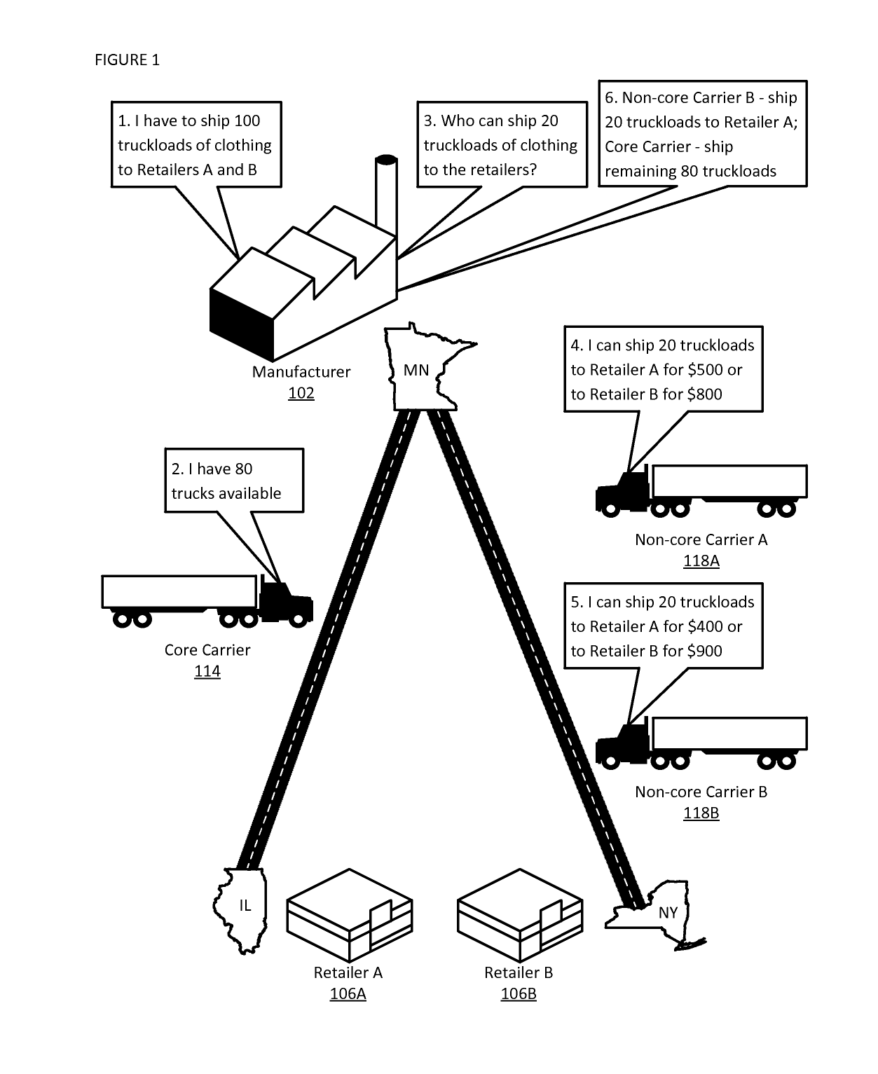

FIG. 1 shows an exemplary usage scenario in one embodiment of the TCAP™ platform. In FIG. 1, a manufacturer 102 may wish to ship freight to retailer A 106A and retailer B 106B. For example, the manufacturer may wish to ship one hundred truckloads of clothing to the retailers. The manufacturer may be located in Minneapolis, Minn. and retailers A and B may be located in Chicago, Ill. and New York, N.Y., respectively.

The manufacturer may typically utilize one or more core carriers, such as a core carrier 114, to ship its freight. In one embodiment, a core carrier may be a contract carrier and/or may commit a specified amount of capacity (e.g., eighty trucks) to ship the manufacturer's freight (e.g., to any agreed upon location). Typically, core carriers may offer lower rates to the manufacturer than the rates that the manufacturer would have to pay on the open market to non-core carriers.

In some situations, the manufacturer may wish to ship more freight (e.g., one hundred truckloads) than the committed capacity of the manufacturer's core carriers (e.g., eighty trucks) allows, and may have to utilize non-core carriers to ship excess freight (e.g., twenty truckloads). Accordingly, the manufacturer may utilize the TCAP™ platform to distribute freight loads among core carriers and non-core carriers effectively (e.g., at the lowest cost to the manufacturer).

The manufacturer may utilize the TCAP™ platform to obtain quotes from non-core carriers regarding shipping the excess freight (e.g., the manufacturer may offer any of the one hundred truckloads to non-core carriers on the open market), and/or to assign shipping of the excess freight to non-core carriers that offered the best quotes (e.g., resulting in the lowest cost to the manufacturer of shipping its freight). For example, carriers may prefer the lane from Minneapolis, Minn. to Chicago, Ill. over the lane from Minneapolis, Minn. to New York, N.Y. (e.g., shorter distance, less traffic). Accordingly, non-core carriers may offer to deliver freight to retailer A for less than to retailer B. Non-core carrier A 118A may offer to deliver twenty truckloads to retailer A for $500 per truckload or to retailer B for $800 per truckload. Non-core carrier B 118B may offer to deliver twenty truckloads to retailer A for $400 per truckload or to retailer B for $900 per truckload. The manufacturer may assign twenty truckloads to be delivered to retailer A to non-core carrier B and the remaining eighty truckloads to the core carrier. Such distribution of freight loads among carriers may result in the lowest shipping cost to the manufacturer.

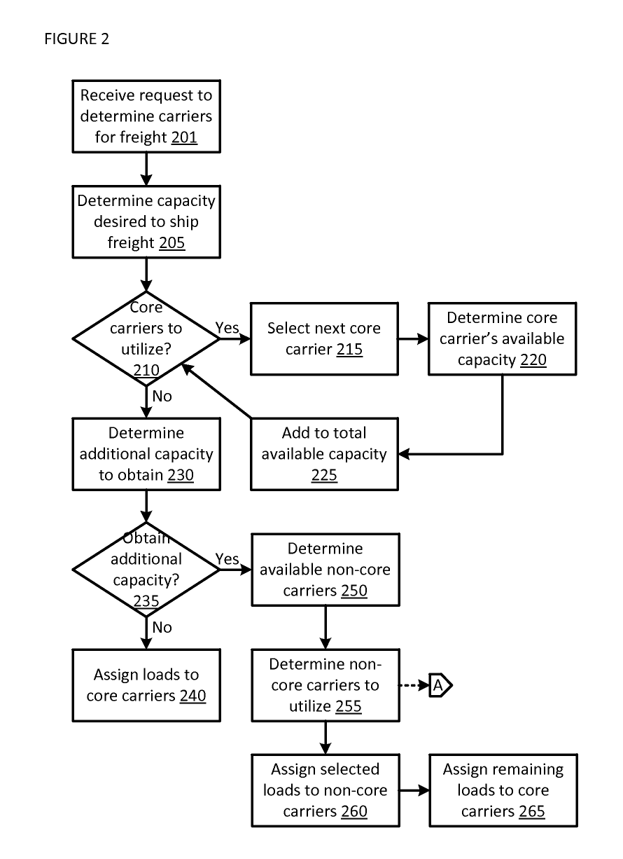

FIG. 2 shows a logic flow diagram illustrating a freight distribution determining (FDD) component in one embodiment of the TCAP™ platform. In FIG. 2, a request to determine carriers for freight may be received at 201. For example, such a request may be received from a user (e.g., an employee of a clothing manufacturer) of the TCAP™ platform via the user's client (e.g., a desktop computer). In one implementation, the TCAP™ platform may be configured to allow the user to send such a request when the user is aware that the user's core carriers do not have enough available capacity to deliver the freight and the user wishes to utilize non-core carriers. In another implementation, the TCAP™ platform may be configured to allow the user to send such a request whenever the user wishes to deliver freight, and the TCAP™ platform may determine whether non-core carriers should be utilized.

Capacity desired to ship the freight may be determined at 205. In one embodiment, the desired capacity may be determined by examining the user's request. For example, one or more programmatic commands (e.g., Perl commands) may be used to parse the user's request to determine the desired capacity specified by the user (e.g., 100 trucks). In another embodiment, data associated with the user's request may be stored in a data store (e.g., freight data store 530c) and the desired capacity may be determined by analyzing data in the data store. For example, the desired capacity may be determined using one or more SQL queries substantially in the following form:

SELECT DesiredCapacity
FROM Freight
WHERE RequestID=”identifier of the request”

In yet another embodiment, the desired capacity may be calculated based on data provided by the user (e.g., in the user's request). For example, the user may specify the type and/or amount of freight (e.g., 50,000 items of clothing), and the TCAP™ platform may calculate how much capacity should be used (e.g., 100 trucks) based on a formula (e.g., 1 truck per 500 items of clothing). In one implementation, such a formula may be specified by the user. In another implementation, such a formula may be specified by a TCAP™ platform administrator.

A determination may be made at 210 whether there remain core carriers whose available capacity may be utilized, which should be analyzed. For example, the clothing manufacturer may have one or more core carriers (e.g., for each lane) typically utilized by the clothing manufacturer to ship clothing. In one embodiment, a data store (e.g., users data store 530a) may be analyzed to make this determination. For example, the clothing manufacturer's core carriers may be determined using one or more SQL queries substantially in the following form:

SELECT CoreCarriersIDs
FROM Users
WHERE UserID=”identifier of the clothing manufacturer”

In one implementation, any core carrier associated with the user may be analyzed. In another implementation, different core carriers may be associated with different types of freight (e.g., some core carriers may be utilized to ship outerwear, while other core carriers may be utilized to ship footwear) and/or different lanes (e.g., some core carriers may be utilized for the Minneapolis, Minn. to Chicago, Ill. lane, while other core carriers may be utilized for the Minneapolis, Minn. to New York, N.Y. lane), and those core carriers that are associated with the freight's type and/or lane may be analyzed.

If there remain core carriers to analyze, the next core carrier may be selected at 215. For example, data regarding the selected core carrier may be retrieved from a data store (e.g., carriers data store 530d) using one or more SQL queries substantially in the following form:

SELECT *
FROM Carriers
WHERE CarrierID=”identifier of the selected core carrier”

The selected core carrier's available capacity may be determined at 220. In one embodiment, available capacity may be capacity committed (e.g., contractually) by the carrier. For example, retrieved data associated with the selected carrier may be analyzed (e.g., parsed) to determine committed capacity. In another embodiment, available capacity may be capacity actually available from the carrier taking into account equipment failures, driver shortages, and/or the like. For example, the selected core carrier may be queried (e.g., via an API command to a server of the selected core carrier) to determine available capacity.

The selected core carrier's available capacity may be added to total available capacity at 225. Accordingly, based on analysis of core carriers whose available capacity may be utilized, the TCAP™ platform may determine total available capacity to ship the freight (e.g., for the freight, for a type of freight and/or lane).

At 230, additional capacity that should be obtained to ship the freight may be determined. In one embodiment, the desired capacity to ship the freight may be compared to the total available capacity to ship the freight to make this determination. For example, total available capacity for the freight may be subtracted from the desired capacity to determine additional capacity that should be obtained, if any. In another example, total available capacity for each type of freight and/or lane may be subtracted from the corresponding desired capacity to determine additional capacity that should be obtained, if any. Additional capacities for each type of freight and/or lane may be summed to calculate total additional capacity that should be obtained to ship the freight.

A determination may be made at 235 whether additional capacity should be obtained. In one embodiment, additional capacity should be obtained if the desired capacity exceeds total available capacity (e.g., for the freight, for a type of freight and/or lane). If additional capacity should not be obtained, the TCAP™ platform may assign freight loads to core carriers at 240. In one embodiment, one or more core carriers having the desired capacity may be utilized. For example, if a core carrier has the desired capacity specified by the user (e.g., 100 trucks), the freight may be assigned to the core carrier.

If additional capacity should be obtained, the TCAP™ platform may determine available non-core carriers that may provide such desired additional capacity at 250. In one embodiment, available non-core carriers may be specified by the user (e.g., for the freight, for a type of freight and/or lane). For example, the clothing manufacturer's non-core carriers may be determined using one or more SQL queries substantially in the following form:

SELECT NonCoreCarriersIDs
FROM Users
WHERE UserID=”identifier of the clothing manufacturer”

In another embodiment, available non-core carriers may be any qualifying carriers on the open market. In some implementations, non-core carriers may have to meet certain service criteria (e.g., delivery track record, insurance coverage, permits, safety rating, use of specified equipment) to be considered.

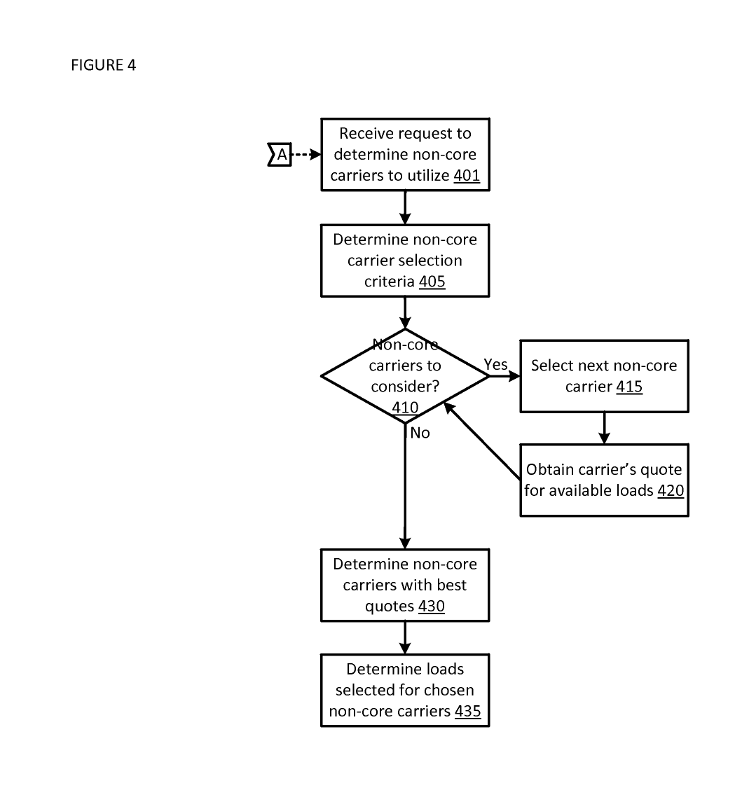

At 255, non-core carriers to utilize to ship the freight may be determined. Considerations such as price, quality of delivery, and/or the like may be utilized to select non-core carriers. In one embodiment, one or more non-core carriers that can provide the desired additional capacity at the lowest price may be chosen (e.g., based on quotes obtained from available non-core carriers) and/or freight loads that result in such lowest price may be selected for assignment to the chosen non-core carriers. See FIG. 4 for additional details regarding choosing non-core carriers to utilize to ship the freight and determining freight loads selected for assignment to the chosen non-core carriers.

Selected freight loads may be assigned to the chosen non-core carriers at 260. For example, an entry may be made in a data store (e.g., freight data store 530c) to indicate that selected freight loads are assigned to a chosen non-core carrier using one or more SQL queries substantially in the following form:

```
INSERT INTO FreightAssignments (RequestID, CarrierID, Capacity,
Lane)
VALUES (”identifier of the request”, “identifier of the chosen non-core
    carrier”, “capacity (e.g., 20 truckloads)”, “lane (e.g.,
    Minneapolis to Chicago)”)
```

In one embodiment, a non-core carrier may be informed (e.g., via an electronic message) that it has been chosen to ship freight and/or which freight loads have been selected for the chosen non-core carrier.

The remaining freight loads may be assigned to core carriers at 265. For example, an entry may be made in a data store (e.g., freight data store 530c) to indicate which freight loads are assigned to a core carrier using one or more SQL queries substantially in the following form:

```
INSERT INTO FreightAssignments (RequestID, CarrierID, Capacity,
Lane)
VALUES (”identifier of the request”, “identifier of the core carrier”,
    “capacity (e.g., 30 truckloads)”, “lane (e.g., Minneapolis to
    Chicago)”);
INSERT INTO FreightAssignments (RequestID, CarrierID, Capacity,
Lane)
VALUES (”identifier of the request”, “identifier of the core carrier”,
    “capacity (e.g., 50 truckloads)”, “lane (e.g., Minneapolis to New
    York)”);
```

In one embodiment, a core carrier may be informed (e.g., via an electronic message) which freight loads are assigned to the core carrier.

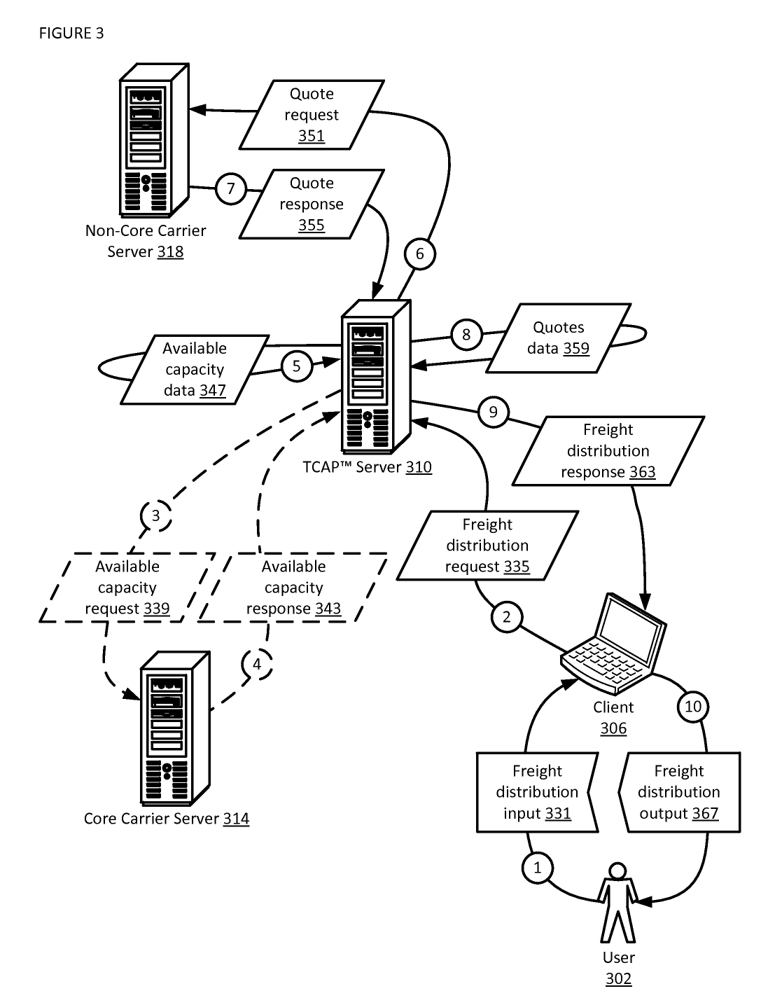

FIG. 3 shows a data flow diagram in one embodiment of the TCAP™ platform. In FIG. 3, dashed arrows indicate data flow elements that may be more likely to be optional. FIG. 3 provides an example of how data may flow to, through, and/or from the TCAP™ platform. In FIG. 3, a user 302 may provide freight distribution input 331 to a client 306. For example, freight distribution input may include a request to determine carriers for freight and may include data such as the desired capacity amount, the type of freight, freight origin, freight destination, carrier selection criteria, shipping date, and/or the like. For example, the client may be a desktop computer, a laptop computer, a tablet, a smartphone, and/or the like. The user may provide freight distribution input via a GUI of the TCAP™ platform using one or more peripheral devices of the client.

The client may send a freight distribution request 335 to a TCAP™ server 310. For example, the freight distribution request may include information from the freight distribution input and may be in XML format substantially in the following form:

```
<XML>
    <FreightDistributionRequest>
        <RequestID>ID_Request</RequestID>
        <UserID>ID_ClothingManufacturer</UserID>
        <Freight>
            <Amount>50 truckloads</Amount>
            <Origin>Minneapolis, MN</Origin>
            <Destination>Chicago, IL</Destination>
            <SelectionCriteria>Price</SelectionCriteria>
            <ShippingDate>Tomorrow</ShippingDate>
        </Freight>
        <Freight>
            <Amount>50 truckloads</Amount>
            <Origin>Minneapolis, MN</Origin>
            <Destination>New York, NY</Destination>
            <SelectionCriteria>Price</SelectionCriteria>
            <ShippingDate>Tomorrow</ShippingDate>
        </Freight>
    </FreightDistributionRequest>
</XML>
```

The TCAP™ server may send an available capacity request 339 to a core carrier server 314. For example, such a request may be sent to determine available capacity for the user (e.g., taking into account equipment failures, driver shortages, and/or the like) from the associated core carrier and may include data such as a request identifier, a carrier identifier, a user identifier, the type of freight, freight origin, freight destination, shipping date, and/or the like. In one implementation, the available capacity request may be in XML format substantially in the following form:

```
<XML>
    <AvailableCapacityRequest>
        <RequestID>ID_Request</RequestID>
        <CarrierID>ID_CoreCarrier</CarrierID>
        <UserID>ID_ClothingManufacturer</UserID>
        <Lane>
            <Origin>Minneapolis, MN</Origin>
            <Destination>Chicago, IL</Destination>
            <ShippingDate>Tomorrow</ShippingDate>
        </Lane>
        <Lane>
            <Origin>Minneapolis, MN</Origin>
            <Destination>New York, NY</Destination>
            <ShippingDate>Tomorrow</ShippingDate>
        </Lane>
    </AvailableCapacityRequest>
</XML>
```

The core carrier server may send an available capacity response 343 to the TCAP™ server. For example, the available capacity response may indicate the associated core carrier's available capacity and may include data such as a request identifier, a carrier identifier, available capacity, and/or the like. In one implementation, the available capacity response may be in XML format substantially in the following form:

```
<XML>
    <AvailableCapacityResponse>
        <RequestID>ID_Request</RequestID>
        <CarrierID>ID_CoreCarrier</CarrierID>
        <AvailableCapacity>80 trucks, may be used for any
lane</AvailableCapacity>
    </AvailableCapacityResponse>
</XML>
```

The TCAP™ server may analyze available capacity data 347 to determine total available capacity from the user's core carriers. For example, available capacity data associated with each of the user's core carriers may be examined and/or summed to determine total available capacity to ship the freight (e.g., for the freight, for a type of freight and/or lane). The TCAP™ server may also determine desired additional capacity.

The TCAP™ server may send a quote request 351 to a non-core carrier server 318. For example, the quote request may be sent to obtain a quote from the associated non-core carrier and may include data such as a request identifier, a carrier identifier, a user identifier, the amount of freight, the type of freight, freight origin, freight destination, carrier selection criteria, shipping date, and/or the like. In one implementation, the quote request may be in XML format substantially in the following form:

```
<XML>
    <QuoteRequest>
        <RequestID>ID_Request</RequestID>
        <CarrierID>ID_NonCoreCarrier</CarrierID>
        <Freight>
            <Amount>50 truckloads</Amount>
            <Origin>Minneapolis, MN</Origin>
            <Destination>Chicago, IL</Destination>
            <ShippingDate>Tomorrow</ShippingDate>
        </Freight>
        <Freight>
            <Amount>50 truckloads</Amount>
            <Origin>Minneapolis, MN</Origin>
            <Destination>New York, NY</Destination>
            <ShippingDate>Tomorrow</ShippingDate>
        </Freight>
    </QuoteRequest>
</XML>
```

The non-core carrier server may send a quote response 355 to the TCAP™ server. For example, the quote response may indicate which freight loads the non-core carrier can deliver, at what price, what quality of delivery the non-core carrier can provide, and/or the like. In one implementation, the quote response may be in XML format substantially in the following form:

```
<XML>
    <QuoteResponse>
        <RequestID>ID_Request</RequestID>
        <CarrierID>ID_NonCoreCarrier</CarrierID>
        <Quote>
            <Amount>20 truckloads</Amount>
            <Origin>Minneapolis, MN</Origin>
            <Destination>Chicago, IL</Destination>
            <Price>$400 per truckload</Price>
            <Quality>GPS Tracking</Quality>
        </Quote>
        <Quote>
            <Amount>20 truckloads</Amount>
            <Origin>Minneapolis, MN</Origin>
            <Destination>New York, NY</Destination>
            <Price>$900 per truckload</Price>
            <Quality>GPS Tracking</Quality>
        </Quote>
    </QuoteResponse>
</XML>
```

The TCAP™ server may analyze quotes data 359 to determine which non-core carriers should provide the desired additional capacity and/or which freight loads should be assigned to the chosen non-core carriers. For example, quotes data may be analyzed based on the specified selection criteria. The TCAP™ server may also determine which freight loads should be assigned to core carriers.

The TCAP™ server may send a freight distribution response 363 to the client. For example, the freight distribution response may indicate which carriers have been selected to deliver the freight and/or which freight loads have been assigned to the chosen carriers. In one implementation, the freight distribution response may be in XML format substantially in the following form:

```
<XML>
    <FreightDistributionResponse>
        <RequestID>ID_Request</RequestID>
        <UserID>ID_ClothingManufacturer</UserID>
        <Freight>
            <CarrierID>ID_NonCoreCarrier</CarrierID>
            <Amount>20 truckloads</Amount>
            <Origin>Minneapolis, MN</Origin>
            <Destination>Chicago, IL</Destination>
        </Freight>
        <Freight>
            <CarrierID>ID_CoreCarrier</CarrierID>
            <Amount>30 truckloads</Amount>
            <Origin>Minneapolis, MN</Origin>
            <Destination>Chicago, IL</Destination>
        </Freight>
        <Freight>
            <CarrierID>ID_CoreCarrier</CarrierID>
            <Amount>50 truckloads</Amount>
            <Origin>Minneapolis, MN</Origin>
            <Destination>New York, NY</Destination>
        </Freight>
    </FreightDistributionResponse>
</XML>
```

The client may provide freight distribution output 367 to the user. For example, the client may display data provided in the freight distribution response via the GUI of the TCAP™ platform using one or more peripheral devices (e.g., a monitor, a printer) of the client.

FIG. 4 shows a logic flow diagram illustrating a non-core carrier determining (NCD) component in one embodiment of the TCAP™ platform. In FIG. 4, a request to determine non-core carriers to utilize to ship the freight may be received at 401. In one embodiment, this request may be received as a result of a programmatic command (e.g., written in PHP).

Non-core carrier selection criteria may be determined at 405. In one implementation, non-core carrier selection criteria may be based on pricing. For example, the TCAP™ platform may be configured to choose non-core carriers with the lowest price. In another implementation, non-core carrier selection criteria may be determined based on user preferences. For example, the clothing manufacturer's non-core carriers selection criteria may be determined using one or more SQL queries substantially in the following form:

SELECT SelectionCriteria
FROM Users
WHERE UserID=”identifier of the clothing manufacturer”

In one embodiment, non-core carriers may have to meet certain service criteria to be considered (e.g., for delivery of any freight, for delivery of a type of freight and/or via a lane). For example, a non-core carrier may have to have a track record of delivering freight reliably, may have to have adequate insurance coverage, may have to have a specified safety rating, may have to have specified permits, may have to have specified equipment (e.g., refrigerated trucks), and/or the like. In another embodiment, non-core carriers may be chosen based on considerations such as price, quality of delivery (e.g., length of transit time, whether freight can be tracked), previous experience utilizing non-core carrier, and/or the like.

A determination may be made at 410 whether there remain non-core carriers to consider. For example, non-core carriers that meet certain service criteria may be considered. In another example, any non-core carrier on the open market may be considered.

If there remain non-core carriers to consider, the next non-core carrier may be selected at 415, and the selected carrier's quote (e.g., price, quality of delivery parameters) for delivering available freight loads may be obtained at 420. For example, the selected carrier's quote may be in XML format and may be analyzed via an XML parser to determine data values. In one embodiment, the selected carrier's quote may be obtained in response to a request for proposal (RFP) (e.g., issued via the TCAP™ platform). In another embodiment, the selected carrier's quote may be obtained based on the selected carrier's bid in an auction (e.g., a Dutch auction to establish the lowest price at which a carrier is willing to deliver freight loads). In yet another embodiment, the selected carrier's quote may be obtained as a response (e.g., willing to deliver at the specified price) to the user's offer on the open market to pay a specified price for delivery of specified freight loads. It is to be understood that any of the available freight loads (e.g., any of the 100 truckloads of clothing with 50 to be shipped via the Minneapolis, Minn. to Chicago, Ill. lane and 50 to be shipped via the Minneapolis, Minn. to New York, N.Y. lane) may be offered to non-core carriers to be delivered. Accordingly, non-core carriers may provide quotes for freight loads that they prefer (e.g., select freight loads that they can delivery effectively), facilitating lower cost of delivery for the user.

One or more non-core carriers with best quotes may be determined at 430. In one embodiment, non-core carriers with best quotes may be chosen based on price. In one implementation, one or more non-core carriers that offer to provide desired additional capacity (e.g., 20 trucks) at the lowest price may be chosen. For example, if the user's core carriers charge a fixed fee (e.g., $32,000) for providing committed capacity (e.g., 80 trucks), choosing non-core carriers based on price may result in the lowest cost to the user of delivering the freight (e.g., 100 truckloads). Accordingly, in the usage scenario described in FIG. 1, non-core carrier B may be chosen since $400 per truckload is the lowest price. In another implementation, one or more non-core carriers that offer to provide desired additional capacity (e.g., 20 trucks) at the lowest price premium over core carriers may be chosen. For example, if the user's core carriers charge different fees for providing capacity (e.g., 80 trucks) for different lanes (e.g., $350 per truckload for the Minneapolis, Minn. to Chicago, Ill. lane and $775 per truckload for the Minneapolis, Minn. to New York, N.Y. lane), choosing non-core carriers based on the lowest price premium over core carriers may result in the lowest cost to the user of delivering the freight (e.g., 100 truckloads). Accordingly, in the usage scenario described in FIG. 1, non-core carrier A may be chosen since $25 ($800-$775 for the Minneapolis, Minn. to Chicago, Ill. lane) per truckload is the lowest price premium over core carriers.

In another embodiment, non-core carriers with best quotes may be chosen based on a variety of selection criteria. In one implementation, non-core carriers may have to meet specified (e.g., by the user) service criteria to be considered. For example, quotes from non-core carriers meeting the specified service criteria may be analyzed, and non-core carriers that offer to provide desired additional capacity at the lowest cost to the user may be chosen. In another implementation, non-core carriers may be compared based on various specified (e.g., by the user) considerations. For example, the user may be willing to pay extra for higher quality of delivery (e.g., extra $10 per truckload to be able to track freight). Accordingly, when comparing quotes from various carriers, quoted prices may be adjusted based on the specified considerations (e.g., prices from carriers that offer tracking may be reduced by $10 for comparison purposes), and non-core carriers that offer to provide desired additional capacity at the lowest adjusted cost to the user may be chosen.

Freight loads selected for the chosen non-core carriers may be determined at 435. This determination may be made based on freight loads selected by the chosen non-core carriers. For example, if a non-core carrier is chosen because the non-core carrier can deliver 10 truckloads via the Minneapolis, Minn. to New York, N.Y. lane at the lowest cost to the user of delivering the freight, such 10 truckloads may be selected for assignment to the chosen non-core carrier. In another example, if a non-core carrier is chosen because $400 per truckload via the Minneapolis, Minn. to Chicago, Ill. lane is the lowest price to obtain desired additional capacity available from non-core carriers, the desired additional capacity (e.g., 20 trucks) may be obtained by selecting 20 truckloads for this lane for assignment to the chosen non-core carrier.

### DETAILED DESCRIPTION OF THE TCAP™ COORDINATOR

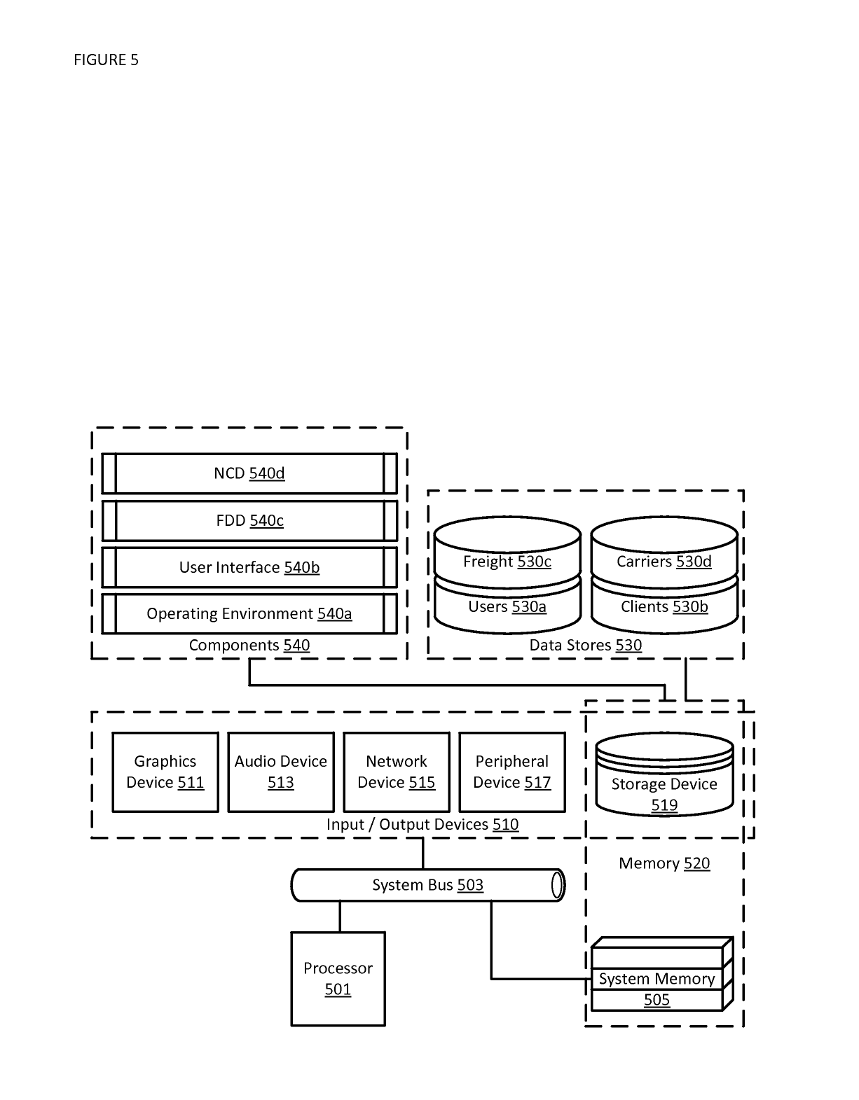

FIG. 5 shows a block diagram illustrating an exemplary TCAP™ coordinator in one embodiment of the TCAP™ platform. The TCAP™ coordinator facilitates the operation of the TCAP™ platform via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the TCAP™ coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the TCAP™ coordinator may comprise a standalone computer system, a distributed computer system, a node in a computer network (i.e., a network of computer systems organized in a topology), a network of TCAP™ coordinators, and/or the like. It is to be understood that the TCAP™ coordinator and/or the various TCAP™ coordinator elements (e.g., processor, system bus, memory, input/output devices) may be organized in any number of ways (i.e., using any number and configuration of computer systems, computer networks, nodes, TCAP™ coordinator elements, and/or the like) to facilitate TCAP™ platform operation. Furthermore, it is to be understood that the various TCAP™ coordinator computer systems, TCAP™ coordinator computer networks, TCAP™ coordinator nodes, TCAP™ coordinator elements, and/or the like may communicate among each other in any number of ways to facilitate TCAP™ platform operation. As used in this disclosure, the term “user” refers generally to people and/or computer systems that interact with the TCAP™ platform; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; the term “node” refers generally to a server, to a client, and/or to an intermediary computer system, program, and/or a combination thereof that facilitates transmission of and/or handling of requests and/or responses.

The TCAP™ coordinator includes a processor 501 that executes program instructions (e.g., TCAP™ platform program instructions). In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may comprise one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be connected to system memory 505 via a system bus 503. The system bus may interconnect these and/or other elements of the TCAP™ coordinator via electrical, electronic, optical, wireless, and/or the like communication links (e.g., the system bus may be integrated into a motherboard that interconnects TCAP™ coordinator elements and provides power from a power supply). In various embodiments, the system bus may comprise one or more control buses, address buses, data buses, memory buses, peripheral buses, and/or the like. In various implementations, the system bus may be a parallel bus, a serial bus, a daisy chain design, a hub design, and/or the like. For example, the system bus may comprise a front-side bus, a back-side bus, AMD's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may comprise registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions (e.g., TCAP™ platform program instructions) executed by the processor. The system memory may facilitate accessing, storing, retrieving, modifying, deleting, and/or the like data (e.g., TCAP™ platform data) by the processor.

In various embodiments, input/output devices 510 may be connected to the processor and/or to the system memory, and/or to one another via the system bus.

In some embodiments, the input/output devices may include one or more graphics devices 511. The processor may make use of the one or more graphic devices in accordance with program instructions (e.g., TCAP™ platform program instructions) executed by the processor. In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data (e.g., TCAP™ platform data). A video card may be connected to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 513. The processor may make use of the one or more audio devices in accordance with program instructions (e.g., TCAP™ platform program instructions) executed by the processor. In one implementation, an audio device may be a sound card that may obtain (e.g., via a connected microphone), process, output (e.g., via connected speakers), and/or the like audio data (e.g., TCAP™ platform data). A sound card may be connected to the system bus via an interface such as PCI, PCI Express, USB, PC Card, ExpressCard, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC'97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 515. The processor may make use of the one or more network devices in accordance with program instructions (e.g., TCAP™ platform program instructions) executed by the processor. In one implementation, a network device may be a network card that may obtain (e.g., via a Category 5 Ethernet cable), process, output (e.g., via a wireless antenna), and/or the like network data (e.g., TCAP™ platform data). A network card may be connected to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKSYS USB300M, a BUFFALO WLI-UC-G450, a Rosewill RNX-MiniN1, a TRENDnet TEW-623PI, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 517. The processor may make use of the one or more peripheral devices in accordance with program instructions (e.g., TCAP™ platform program instructions) executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be connected to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the TCAP™ coordinator with a variety of input, output and processing capabilities.

In some embodiments, the input/output devices may include one or more storage devices 519. The processor may access, read from, write to, store in, erase, modify, and/or the like a storage device in accordance with program instructions (e.g., TCAP™ platform program instructions) executed by the processor. A storage device may facilitate accessing, storing, retrieving, modifying, deleting, and/or the like data (e.g., TCAP™ platform data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 505 and the one or more storage devices 519 may be referred to as memory 520 (i.e., physical memory).

TCAP™ platform memory 520 contains processor-operable (e.g., accessible) TCAP™ platform data stores 530. Data stores 530 comprise data that may be used (e.g., by the TCAP™ platform) via the TCAP™ coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, TCAP™ coordinator elements, and/or the like) to facilitate TCAP™ platform operation. For example, TCAP™ platform data stores may comprise data stores 530a-d implemented as one or more databases. A users data store 530a may be a collection of database tables that include fields such as UserID, UserName, UserPreferences, CoreCarriersIDs, and/or the like. A clients data store 530b may be a collection of database tables that include fields such as ClientID, ClientName, ClientDeviceType, ClientScreenResolution, and/or the like. A freight data store 530c may be a collection of database tables that include fields such as RequestID, DesiredCapacity, Lane, Origin, Destination, ShippingDate, SelectionCriteria, DeliveryPrice, DeliveryQuality, and/or the like. A carriers data store 530d may be a collection of database tables that include fields such as CarrierID, CarrierName, CommittedCapacity, AvailableCapacity, and/or the like. The TCAP™ coordinator may use data stores 530 to keep track of inputs, parameters, settings, variables, records, outputs, and/or the like.

TCAP™ platform memory 520 contains processor-operable (e.g., executable) TCAP™ platform components 540. Components 540 comprise program components (including program instructions and any associated data stores) that are executed (e.g., by the TCAP™ platform) via the TCAP™ coordinator (i.e., via the processor) to transform TCAP™ platform inputs into TCAP™ platform outputs. It is to be understood that the various components and their subcomponents, capabilities, applications, and/or the like may be organized in any number of ways (i.e., using any number and configuration of components, subcomponents, capabilities, applications, TCAP™ coordinator elements, and/or the like) to facilitate TCAP™ platform operation. Furthermore, it is to be understood that the various components and their subcomponents, capabilities, applications, and/or the like may communicate among each other in any number of ways to facilitate TCAP™ platform operation. For example, the various components and their subcomponents, capabilities, applications, and/or the like may be combined, integrated, consolidated, split up, distributed, and/or the like in any number of ways to facilitate TCAP™ platform operation. In another example, a single or multiple instances of the various components and their subcomponents, capabilities, applications, and/or the like may be instantiated on each of a single TCAP™ coordinator node, across multiple TCAP™ coordinator nodes, and/or the like.

In various embodiments, program components may be developed using one or more programming languages, techniques, tools, and/or the like such as an assembly language, Ada, BASIC, C, C++, C#, COBOL, Fortran, Java, LabVIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), Simple Object Access Protocol (SOAP), SSL, ColdFusion, Microsoft .NET, Apache modules, Adobe Flash, Adobe AIR, Microsoft Silverlight, Windows PowerShell, batch files, Tcl, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 540 may include an operating environment component 540a. The operating environment component may facilitate operation of the TCAP™ platform via various subcomponents.

In some implementations, the operating environment component may include an operating system subcomponent. The operating system subcomponent may provide an abstraction layer that facilitates the use of, communication among, common services for, interaction with, security of, and/or the like of various TCAP™ coordinator elements, components, data stores, and/or the like.

In some embodiments, the operating system subcomponent may facilitate execution of program instructions (e.g., TCAP™ platform program instructions) by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the TCAP™ platform. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the TCAP™ coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the TCAP™ coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the TCAP™ platform by providing user interface elements that may be used by the TCAP™ platform to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may comprise a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may comprise an operating system such as UNIX, LINUX, IBM i, Sun Solaris, Microsoft Windows Server, Microsoft DOS, Microsoft Windows 7, Microsoft Windows 8, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate TCAP™ platform capabilities such as storage, analysis, retrieval, access, modification, deletion, aggregation, generation, and/or the like of data (e.g., the use of data stores 530). The database subcomponent may make use of database languages (e.g., Structured Query Language (SQL), XQuery), stored procedures, triggers, APIs, and/or the like to provide these capabilities. In various embodiments the database subcomponent may comprise a cloud database, a data warehouse, a distributed database, an embedded database, a parallel database, a real-time database, and/or the like. For example, the database subcomponent may comprise a database such as Microsoft SQL Server, Microsoft Access, MySQL, IBM DB2, Oracle Database, and/or the like.

In some implementations, the operating environment component may include an information handling subcomponent. The information handling subcomponent may provide the TCAP™ platform with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, TCAP™ platform components, nodes in a computer network, web browsers, and/or the like. For example, the information handling subcomponent may comprise a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 530) via the database subcomponent.

In some embodiments, the information handling subcomponent may facilitate presentation of information obtained from users, TCAP™ platform components, nodes in a computer network, web servers, and/or the like. For example, the information handling subcomponent may comprise a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate TCAP™ platform message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, a custom protocol, and/or the like to facilitate TCAP™ platform message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may comprise Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates TCAP™ platform security. In some embodiments, the security subcomponent may restrict access to the TCAP™ platform, to one or more services provided by the TCAP™ platform, to data associated with the TCAP™ platform (e.g., stored in data stores 530), to communication messages associated with the TCAP™ platform, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the TCAP™ platform may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may comprise a cryptographic system such as Pretty Good Privacy (PGP).

In some implementations, the operating environment component may include a virtualization subcomponent that facilitates TCAP™ platform virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may comprise VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 540 may include a user interface component 540b. The user interface component may facilitate user interaction with the TCAP™ platform by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In some embodiments, components 540 may include any of the components FDD 540c, NCD 540d described in more detail in preceding figures.

### The Embodiments of the TCAP™ Platform

The entirety of this disclosure (including the written description, figures, claims, abstract, appendices, and/or the like) for TRANSPORTATION CAPACITY AUGMENTATION PROGRAM METHODS, APPARATUSES AND MEDIA shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure. Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the TCAP™ coordinator, TCAP™ coordinator elements, TCAP™ platform data stores, TCAP™ platform components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the TCAP™ coordinator, TCAP™ coordinator elements, TCAP™ platform data stores, TCAP™ platform components and their subcomponents, capabilities, applications, and/or the like described in various embodiments throughout this disclosure are not limited to serial execution, instead, any number and/or configuration of threads, processes, instances, services, servers, clients, nodes, and/or the like that execute in parallel, concurrently, simultaneously, synchronously, asynchronously, and/or the like is contemplated by this disclosure.

Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the TCAP™ platform discussed in this disclosure have been directed to transportation capacity augmentation, the innovations described in this disclosure may be readily applied to a wide variety of other fields and/or applications.

1-20. (canceled)

21. A processor implemented method to facilitate shipping of freight, comprising:
a) receiving via a processor freight capacity request input for a shipment, the freight capacity request input requesting freight capacity in excess of available core carrier freight capacity;
b) obtaining via the processor from at least one non-core carrier a non-core carrier quote for providing additional freight capacity to supplement the core carrier freight capacity, wherein the quote comprises GPS tracking data for the at least one non-core carrier;
c) selecting the non-core carrier quote via processor to provide the additional freight capacity; and
d) assigning via the processor shipment of at least a portion of the shipment to at least one core carrier after selecting the non-core carrier quote.

22. The method of claim 21, wherein the at least one non-core carrier is one of a plurality of available non-core carriers.

23. The method of claim 21, wherein the non-core carrier is any qualifying non-core carrier on the open market.

24. The method of claim 21, wherein the non-core carrier quote is obtained based on the non-core carrier meeting specified service criteria.

25. The method of claim 21, wherein the non-core carrier quote is obtained based on the at least one non-core carrier's bid in a Dutch auction.

26. The method of claim 21, wherein the non-core carrier quote is obtained in response to an offer to pay a specified price for delivery of specified freight loads on the open market.

27. The method of claim 21, wherein the non-core carrier quote is chosen based on a price associated with the quote.

28. The method of claim 21, wherein the non-core carrier is chosen based on a plurality of selection criteria including quality of delivery.

29. The method of claim 21, wherein choosing the non-core carrier results in the lowest cost of delivering the freight.

30. The method of claim 21, wherein choosing the non-core carrier includes selecting freight loads for assignment to the non-core carrier.

31. The method of claim 30, wherein at least a portion of a freight load specified by the non-core carrier in the quote is selected for assignment to the non-core carrier.

32. The method of claim 21, wherein a plurality of non-core carrier quotes are obtained via the processor for providing additional freight capacity to supplement the core carrier freight capacity.

33. (canceled)

34. An apparatus to facilitate shipping of freight, comprising a memory, a processor in communication with the memory, the processor being configured to issue a plurality of processing instructions stored in the memory to:
a) receive via the processor freight capacity request input for a shipment, the freight capacity request input requesting freight capacity in excess of available core carrier freight capacity;
b) obtain via processor from at least one non-core carrier a non-core carrier quote for providing additional freight capacity to supplement the core carrier freight capacity, wherein the quote comprises GPS tracking data for the at least one non-core carrier;
c) select the non-core carrier quote via processor to provide the additional freight capacity; and
d) assign via processor shipment of at least a portion of the shipment to at least one core carrier after selecting the non-core carrier quote.

35. The system of claim 34, wherein the at least one non-core carrier is one of a plurality of available non-core carriers.

36. The system of claim 34, wherein the non-core carrier is any qualifying non-core carrier on the open market.

37. A processor-readable physical medium to facilitate shipping of freight storing processor-issuable instructions to:
a) receive via processor freight capacity request input for a shipment, the freight capacity request input requesting freight capacity in excess of available core carrier freight capacity;
b) obtain via processor from at least one non-core carrier a non-core carrier quote for providing additional freight capacity to supplement the core carrier freight capacity, wherein the quote comprises GPS tracking data for the at least one non-core carrier;
c) select the non-core carrier quote via processor to provide the additional freight capacity; and
d) assign via processor shipment of at least a portion of the shipment to at least one core carrier after selecting the non-core carrier quote.

38. The medium of claim 37, wherein the processor-issuable instructions include instructions to receive the non-core carrier quote based on the at least one non-core carrier's bid in a Dutch auction.

39. The medium of claim 38, wherein the processor-issuable instructions include instructions to obtain a plurality of non-core carrier quotes via the processor for providing additional freight capacity to supplement the core carrier freight capacity.

40. (canceled)
